(19) United States
(12) Patent Application Publication
(10) Pub. No.: US 2018/0239111 A1
(43) Pub. Date: Aug. 23, 2018

(54) Dual Focal Length Lens Design

(71) Applicant: DynaOptics Ltd, Singapore (SG)

(72) Inventor: Vadim Vlakhko, Moscow (RU)

(21) Appl. No.: 15/958,869

(22) Filed: Apr. 20, 2018

Related U.S. Application Data
(63) Continuation-in-part of application No. PCT/IB2016/001615, filed on Oct. 20, 2016.
(60) Provisional application No. 62/244,172, filed on Oct. 20, 2015.

(51) Int. Cl. G02B 13/00; H04N 5/225; G02B 7/10; G02B 15/14

(52) U.S. Cl. CPC G02B 13/009; H04N 5/2253; G02B 15/14; G02B 7/10; H04N 5/2254

(57) ABSTRACT

An optical zoom in a small form factor suitable for use in mobile devices such as cell phones, security cameras, and other small-scale imaging systems. The zoom design comprises a zoom submodule and a focusing sub-module. The zoom sub-module comprises a pair of lens frames, typically positioned on either side of a prism. Each of a pair of lens frames comprises a plurality of optically active areas. Each of the optically active areas on a first lens frame is complementary to a corresponding optically active area on a second lens frame, so that the complementary areas provide different optical powers. By moving the lens frames orthogonally to the optical axis, a complementary pair of optical areas is selected for alignment with the optical axis of the focusing sub-module, providing zoom of the image striking a sensor.

### RELATED APPLICATIONS

This application is a continuation-in-part of PCT Application PCT/162016/001615 having an international filing date of 20 Oct. 2016, which in turn is a conversion of U.S. patent application Ser. No. 62/244,172, filed 20 Oct. 2015. The present application claims the benefit of priority of each of the foregoing applications, all of which are incorporated herein for all purposes.

### FIELD OF THE INVENTION

This invention relates to lens assemblies for use in combination with imaging sensors, and more particularly relates to lens assemblies and actuators for providing optical zoom in devices such as cameras integrated into cellular phones, security cameras, and other small form factor imaging devices, particularly those which benefit from a small Z dimension.

### BACKGROUND OF THE INVENTION

The proliferation of small scale optical systems for use in, for example, a variety of miniature devices, such as cellphones, tablets, and surveillance cameras, places significant challenges on the design of lens modules due to the required small form factor yet still requiring good performance.

In many modern optical systems, zoom can also be achieved through software means, typically referred to as “digital zoom.” Digital zoom is a method of decreasing (narrowing) the apparent angle of view of a digital photographic or video image. Digital zoom is accomplished by cropping an image down to a centered area with the same aspect ratio as the original. Digital zoom is accomplished electronically, with no adjustment of the camera's optics, and no optical resolution is gained in the process. The cropping leads to a reduction in the quality of the image. In many instances, digital zoom also includes interpolating the result back up to the pixel dimensions of the original. This combination of cropping and enlargement of the pixels typically creates a pixelation/mosaic effect in the image, and typically introduces interpolation artifacts. Such pixelation typically results in an image of significantly reduced quality. In addition, digital zoom has typically been implemented as a series of increments, rather than continuous zoom. Thus, for example, some digital zooms are implemented in one-tenth power increments, while others use larger increments. This corresponds to a reduction in the effective size of the sensor.

Unlike digital zoom, optical zoom has long been used in photography and other optical systems to provide zoom without loss of image quality. Typical lens systems which provide optical zoom using concave or convex lens elements move one or more lens elements along the optical axis, and in most such systems the optical center of each lens element is located on the optical axis. While such systems can provide excellent image clarity, they require that the lens elements travel too great a distance to be suitable for many applications which require a small form factor. For example, in cameras used in cellular phones, the electronics of the cellular phone imposes severe limits on the form factor of the lens module used in the cell phone's camera, and such limits prohibit the use of conventional optical zoom.

There has therefore been a long felt need for an optical system suitable for use in mobile devices such as cellular phones or other small scale systems which provides the clarity of optical zoom in a small form factor, yet does not require excessive power.

### SUMMARY OF THE INVENTION

The present invention provides optical zoom in a small form factor suitable for use in mobile or other small form factor devices such as cell phones, tablets, IP cameras or webcams, security cameras, action cams, dash cams, and other small-scale imaging systems. To achieve the requisite small form factor required for some of these devices, though not all, the present invention comprises an optical zoom design in which a zoom sub-module and a focusing sub-module cooperate to provide a miniature zoom lens of less than 6.5 mm Z-height, or thickness. Other embodiments need not be limited to such Z-height. To simplify optical design and satisfy the requirement for low power, the zoom sub-module comprises a plurality of lens structures, each having a different focal length. The zoom sub-module moves in a direction substantially perpendicular to the optical axis, to cause alignment of the desired lens structure in the zoom sub-module with the optical axis of the focusing sub-module.

Thus, for a lens design having two discrete focal lengths, the zoom sub-module comprises a first lens arrangement for the first focal length, and a second lens arrangement for the second focal length. The lenses are mounted on a frame, and the frame is moved laterally to select different focal lengths.

By simplifying the lens structures, a Z-height of less than 6.5 mm can be achieved. In addition, each optically active area of the frame can have a different optical power, and only a single actuator is needed to move among zoom positions. The optically active areas can be of any suitable type, including spherical, aspherical, rotationally symmetric, double plane symmetric, anamorphic, etc. In addition, a different aperture can be implemented with each different focal length.

It is therefore one object of the present invention to provide a camera's lens module with optical zoom sized to fit within the form factor of small devices such as smartphones without increasing the height of the smartphone.

It is another object of the present invention to provide optical zoom in a lens module configured to fit within the form factor required for a camera integrated into a smartphone.

It is a further object of the present invention to provide an optical system comprising an actuator and at least one lens pair wherein the actuator moves the lenses in a direction other than parallel to or collinear with the optical axis of the system to achieve zoom.

These and other objects of the present invention will be better appreciated from the following detailed description, taken in combination with the Figures described hereinafter.

### THE FIGURES

FIG. 1 illustrates in side view an embodiment of an optical system which provides optical zoom with lateral actuation in accordance with the present invention.

FIG. 2 illustrates in perspective view an embodiment of a lens frame having a plurality of active lens areas in accordance with the invention.

FIG. 3 an embodiment of an aperture plate or frame having separate apertures associated with each optically active area of the lens frame.

FIGS. 4A-4B show in perspective view the relationship of lens frames, aperture plate, and prism in accordance with an embodiment of the invention.

FIGS. 5A-5B show in front elevational view and side view, respectively, the relationship of the aperture plate to the lens frames and prism.

FIGS. 6A-6B shows in side view an alternative structure in accordance with an aspect of the invention, where the active areas of the lens frames comprise rotationally symmetric lenses.

FIG. 7 shows an alternative arrangement to that shown in FIG. 1.

### DETAILED DESCRIPTION OF THE INVENTION

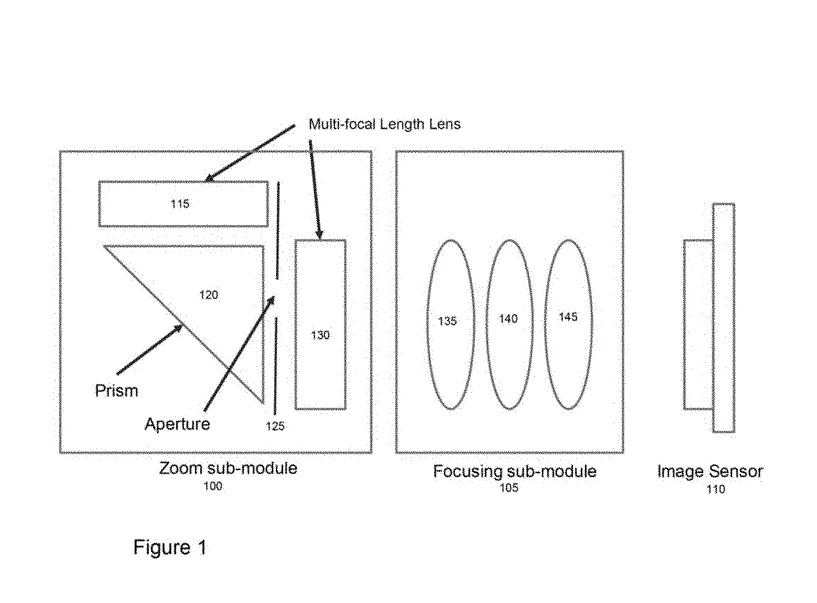

Referring first to FIG. 1, an optical system in accordance with the present invention is shown to comprise a zoom sub-module 100 which cooperates with a focusing sub-module 105 to project an image onto sensor 110. In simplest terms, light impinging on zoom sub-module 100 initially passes through first multi-focal length lens 115, then is reflected by prism 120, passes through an aperture in aperture plate 125, and finally passes through second multi-focal length lens 130. At that point the ray exits the zoom sub-module and enters focusing sub-module 105, where it passes through one or more focusing elements, indicated at 135-145, which can be of any suitable type such rotationally symmetric lens elements, free-form, etc. Light exiting the focusing sub-module then strikes image sensor 110 where it is converted into recordable signals. A prism is not required in all embodiments, although Z-height may increase.

To permit a user to zoom in on a subject, the multi-focal length lenses 115 and 130 each comprise a plurality of optically active areas on a single lens frame. The corresponding optically active areas of lenses 115 and 130 are maintained in optical alignment with one another, and together cooperate to provide different effective focal lengths simply by selecting the optically active area of the multi-focal length lens pair having the desired focal length and moving it into position on the optical axis. The lens frame is moved laterally—i.e., substantially orthogonal to the optical axis—to align the selected active area with the optical axis of the focusing sub-module. The lateral movement of the lens frame thus causes a change in focal length, providing image magnification, or optical zoom.

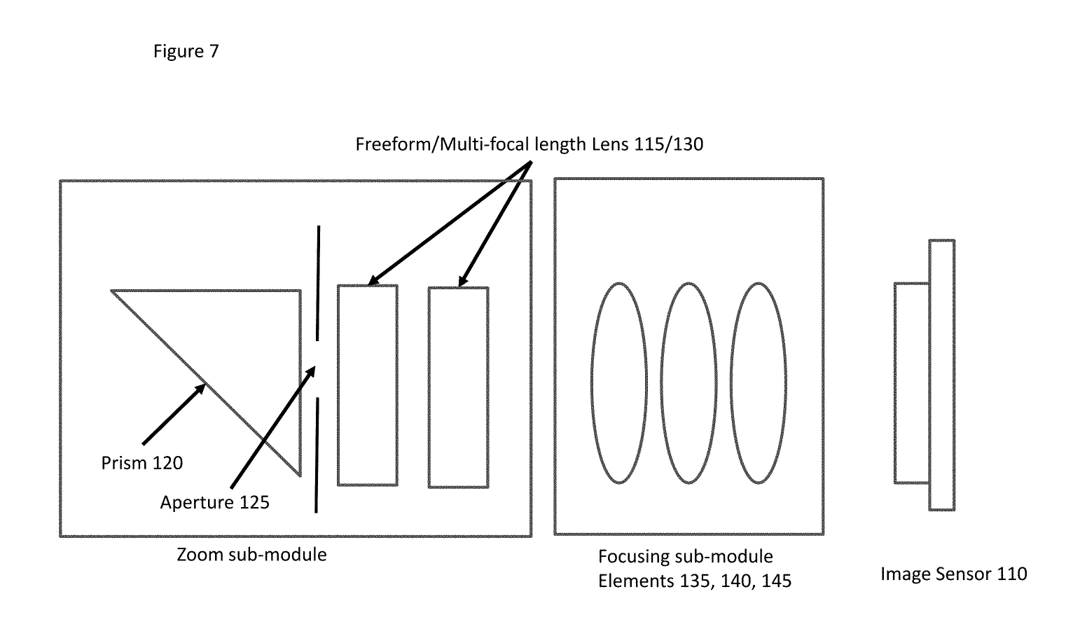

In another embodiment, shown in FIG. 7, light impinging on zoom sub-module initially passes through a prism or mirror before reaching the aperture in aperture plate of the system. The ray then passes through the first multi-focal length lens and the subsequent second multi-focal length lens. At that point the ray exits the zoom sub-module and enters focusing sub-module, where it passes through one or more focusing elements, indicated at xxx, which can be of any suitable type such rotationally symmetric lens elements, free-form, etc. Light exiting the focusing sub-module then strikes image sensor 110 where it is converted into recordable signals.

In yet another embodiment that is a minor variation from FIG. 7 and thus not shown separately, the aperture can be placed between the freeform lens 115/130. Light impinging on zoom sub-module initially passes through a prism or mirror before reaching the first multi-focal length lens. The ray then passes through the aperture in the aperture plate of the system and the subsequent second multi-focal length lens. At that point the ray exits the zoom sub-module and enters focusing sub-module, where it passes through one or more focusing elements, indicated at xxx, which can be of any suitable type such rotationally symmetric lens elements, free-form, etc. Light exiting the focusing sub-module then strikes image sensor 110 where it is converted into recordable signals.

The latter two configurations significantly reduces the complexity and precision level of assembly required.

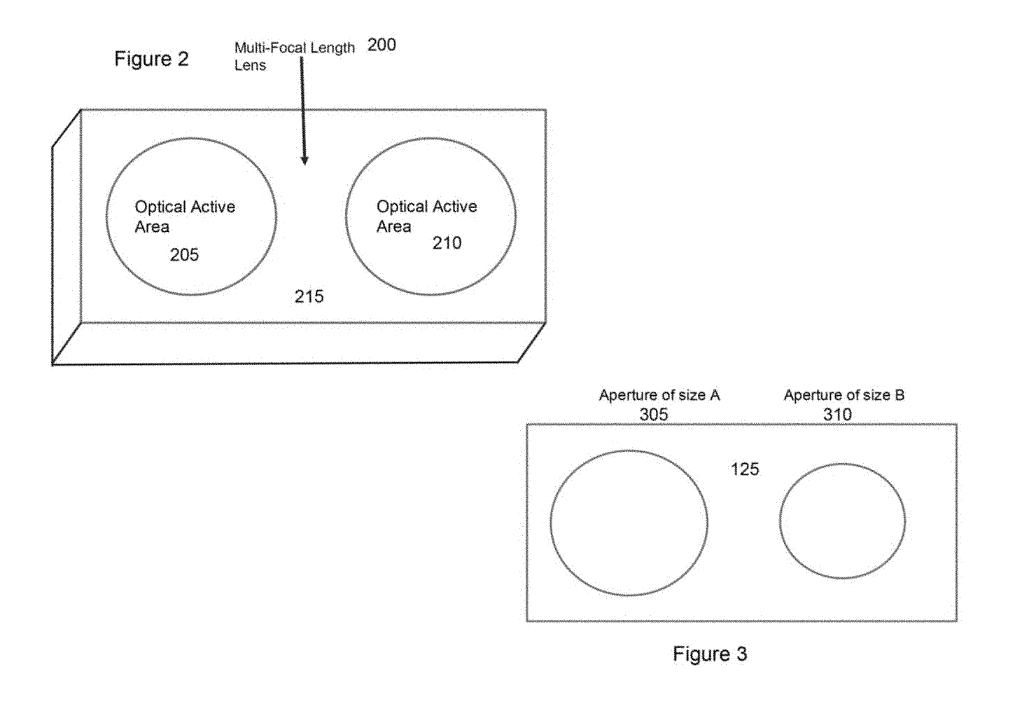

The foregoing operation can be better understood with reference to FIGS. 2 and 3. FIG. 2 illustrates a multi-focal length lens 200 comprising first optically active area 205 and second optically active area 210 mounted on lens frame 215. It will be appreciated that each of multi-focal length lenses 115 and 130 are structurally as shown for multi-focal length lens 200, but with complementary optically active areas, such that the first optically active area of lens 115 cooperates with the first optically active area of lens 130 to offer a first magnification, and the second optically active area of lens 115 cooperates with the second optically active area of lens 130 to offer a second magnification.

It will also be appreciated by those skilled in the art that, while multi-focal length lens 200 is shown formed as a single integrated structure of the lens frame and the plurality of optically active areas, the lens could alternatively be formed as a separate structure or lens frame for each optically active area. Those separate structures or lens frames could then actuated separately or together, or could be affixed to one another to form a unitary structure. Further, it can be appreciated that each optically active area can be characterized with its own optical power, and, in at least some embodiments, does not overlap with the physical profile of any other optically active area. In addition, only a single actuator is needed to select among zoom positions. Further, the lateral travel range between zoom positions can be less than about seven millimeters where the Z-height is less than about 6.5 millimeters. Depending upon the embodiment, the prism 120 can be moved with the lens frame or kept stationary. It will also be appreciated that, depending upon the application, additional lenses can be implemented and mounted on additional lens frames, although such embodiments will in at least some cases exceed a Z height of 6.5 millimeters.

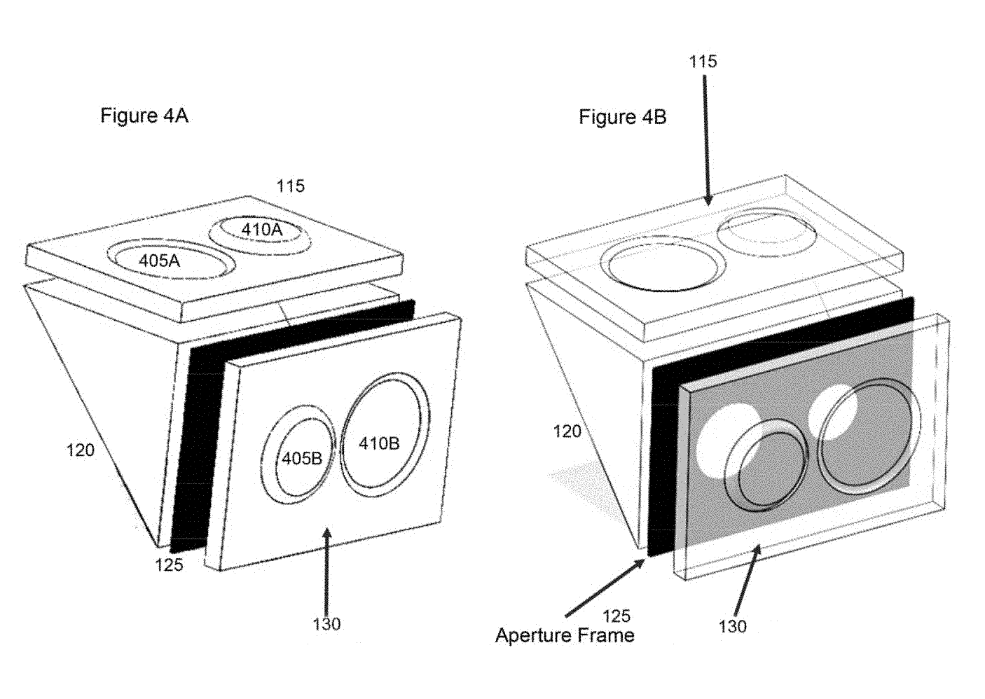

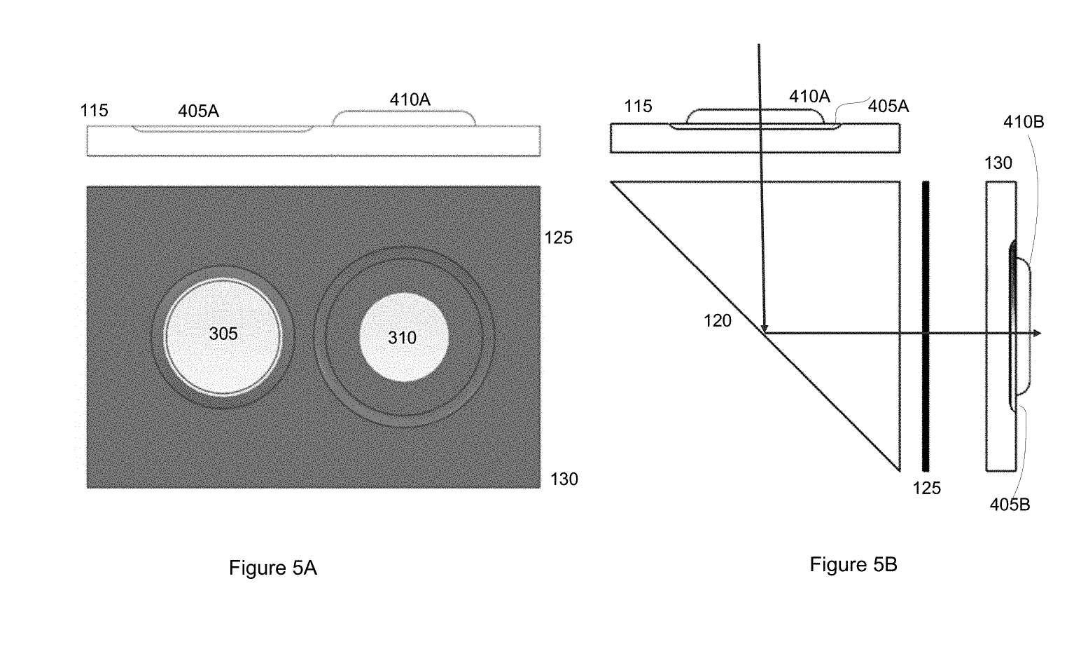

Referring next to FIG. 3, which illustrates aperture plate 125 is front elevational view, and also to FIGS. 4A-4B and 5A-5B, which illustrate aperture plate 125 in relationship to prism 120 and lenses 115 and 130, an additional feature of the lens design of the current invention can be better appreciated. More specifically, the aperture plate 125 of FIG. 1 can be seen, in at least some embodiments, to comprise a separate aperture for each optically active area of lenses 115 and 130. For a lens frame having two optically active areas, different sized apertures 305 and 310 can be matched to the optical characteristics, including f-number, of each associated lens arrangement. Thus, for example, if the magnification provided by the first optically active area is 3×, and the magnification provided by the second optically active area is 1×, the apertures in plate 125 can be sized to provide identifical f-numbers at each magnification.

In some embodiments, it may be desirable to simplify the aperture structure, such as by fixedly positioning the aperture plate with respect to the prism rather than moving the aperture plate with the lens 130. In such an event, a single aperture can be used, although the f-number will vary with the optical power of the lens pairs.

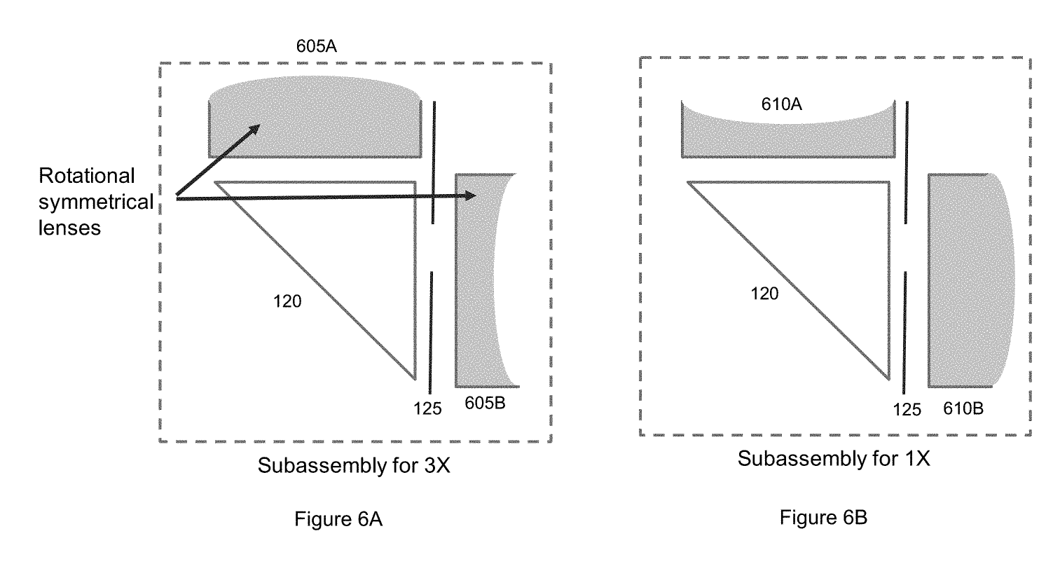

Referring next to FIGS. 6A-65B, an alternative arrangement is shown in which lenses 405A-B and 410A-B of FIGS. 4A-4B are converted to complementary rotationally symmetric pairs 605A-B and 610A-B. In particular, FIG. 6A shows a zoom sub-assembly for 3×, and FIG. 6B shows a zoom sub-assembly for 1×.

Having fully described multiple embodiments of the invention, those skilled in the art will recognize that there are many alternatives and equivalents which do not depart from the scope of the invention. As such, the invention is not to be limited by the foregoing description, but only by the appended claims.

I claim:

1. A optical zoom system comprising
multi-focal length lenses each comprising a plurality of optically active areas on a single lens frame,
the corresponding optically active areas of lenses are maintained in optical alignment with one another and together cooperate to provide different effective focal lengths simply by selecting the optically active area of the multi-focal length lens pair having the desired focal length and moving it into position on the optical axis,
the lens frame is moved laterally to align the selected active area with the optical axis of the focusing sub-module.
